(19) United States
(12) Patent Application Publication
(10) Pub. No.: US 2011/0004591 A1
(43) Pub. Date: Jan. 6, 2011

(54) Portable Electronic Apparatus and Operating Method Thereof

(75) Inventor: Shih Hao Chen, Hsinchu Hsien (TW)

Correspondence Address: LEE & HAYES, PLLC, 601 W. RIVERSIDE AVENUE, SUITE 1400, SPOKANE, WA, 99201, US

(73) Assignee: MSTAR SEMICONDUCTOR, INC., Hsinchu Hsien (TW)

(21) Appl. No.: 12/813,365

(22) Filed: Jun. 10, 2010

(30) Foreign Application Priority Data
Jul. 1, 2009 (TW) 098122331

(51) Int. Cl. G06F 17/30

(52) U.S. Cl. 707/723; 707/722; 707/E17.014; 707/E17.045

(57) ABSTRACT

A portable electronic apparatus includes a database, a calculating module, a retrieving module, a ranking module and a display module. The database is used to store a plurality of contact information. The calculating module calculates a plurality of relative distances between the plurality of contact information and a target position, and generates a plurality of marked information by comparing the relative distances with a predetermined distance. The retrieving module retrieves a map image according to the target position and the predetermined distance. The ranking module ranks the marked information according to the relative distances to generate a ranking result. The display module displays the map image and the marked information according to the ranking result simultaneously.

### CROSS REFERENCE TO RELATED PATENT APPLICATIONS

This patent application claims priority from Taiwan Patent Application No. 098122331, filed in the Taiwan Patent Office on Jul. 1, 2009, entitled Portable Electronic Apparatus and Operating Method Thereof“, and incorporates the Taiwan patent application in its entirety by reference.

### TECHNICAL FIELD

The present disclosure relates to wireless communication, and more particularly, to a portable electronic apparatus and an operating method thereof capable of ranking a plurality of contact information according to relative distances between the contact information and a target position, and displaying the contact information in conjunction with a corresponding map image on a screen.

### BACKGROUND OF THE PRESENT DISCLOSURE

As the wireless communication technology continuously develops, various types of portable electronic apparatuses, e.g., smart phones, personal digital assistants (PDAs), and the like, have become indispensable communication tools in the daily life of modern people. In addition, since the satellite positioning technology is maturing day by day, novel mobile phones with various functions, such as a positioning and navigation function and a map image quest function, for meeting requirements of mobile phone users are now market available.

Although mobile phones provide more and more powerful functions, when a user operates a mobile phone for map quest, inconveniences and complications may be encountered. For example, as a current position of the mobile phone changes when a user handholding the mobile phone begins moving, a plurality of contact information entries displayed on a phone book of the mobile phone are not changed to rank from near to far according to the position change of the user. Accordingly, the user cannot obtain an order of relative distances between the positions of the contact information entries and a target position, such that great inconveniences are created.

In addition, when the user wishes to map quest according to his predetermined requirements and purposes, e.g., a supermarket nearest to the target position of the user, the current mobile phone can neither auto-search contact information that matches the predetermined requirements and purposes nor rank and display on a screen the contact information entries from near to far according to the position change of the user. Therefore, as for the user, the map quest function and an interface of the current mobile phone still lack humanization.

Therefore, one main object of the present disclosure is to provide a portable electronic apparatus and an operating method thereof to solve the foregoing problem.

### SUMMARY OF THE PRESENT DISCLOSURE

According to an embodiment of the present disclosure, a portable electronic apparatus comprises a database, a calculating module, a ranking module, a retrieving module and a display module. The database is used to store a plurality of contact information. The calculating module calculates a plurality of relative distances between the plurality of contact information and a target position, and generates a plurality of marked information by comparing the relative distances with a predetermined distance. The retrieving module retrieves a map image according to the target position and the predetermined distance. The ranking module ranks the marked information according to the relative distances to generate a ranking result. The display module displays the map image and the marked information according to the ranking result simultaneously.

According to another embodiment of the present disclosure, a portable electronic apparatus comprises a database, a calculating module, a ranking module, a retrieving module and a display module. The database is used to store a plurality of contact information. The calculating module calculates a plurality of relative distances between the plurality of contact information and a target position. The ranking module ranks the plurality of contact information according to the relative distance information, and selecting a plurality of marked information from the ranked contact information. The retrieving module retrieves a corresponding map image according to the target position and the plurality of marked information. The display module displays the map image and the plurality of marked information simultaneously.

According to another embodiment of the present disclosure, a method for operating a portable electronic apparatus having a database storing a plurality of contact information comprises calculating a plurality of relative distances between the plurality of contact information and a target position; generating a plurality of marked information by comparing the relative distances with a predetermined distance; ranking the marked information according to relative distances; retrieving a map image according to the target position and the predetermined distance; and displaying the map image and the marked information simultaneous.

According to yet another embodiment of the present disclosure, a method for operating a portable electronic apparatus comprises respectively calculating relative distances between a plurality of connect information and a target position to obtain distance information corresponding to the plurality of connect information; ranking the plurality of connect information according to the predetermined distance to generate a ranking result, and selecting a plurality of marked information from the ranking result; retrieving a corresponding map image according to the target position and the plurality of marked information; and displaying the map image and the plurality of marked information according to the ranking result.

Compared to the prior art, regardless of whether a target position is inputted by a user or is calculated via received signals from a satellite positioning system, a portable electronic apparatus according to the present disclosure ranks a plurality of contact information entries in a phone book according to relative distances between positions corresponding to the plurality of contact information entries and the target position from near to far to generate a ranking result, and an image comprising the ranking result and a corresponding map image are displayed on a screen. In addition, the user may map quest with respect to predetermined requirements and purposes (e.g., a restaurant or a bank within a kilometer radius from the target position) via the portable electronic apparatus according to the present disclosure, so that names and phone numbers of restaurants or banks matching with predetermined requirements and purposes are ranked from near to far according to relative distances between the restaurants or the banks and the target position, with the ranking result and a corresponding map image being displayed on the screen.

Accordingly, according to the present disclosure, a portable electronic apparatus is capable of assisting a user to easily obtain contact information and associated life information of locations near a target position via simple operations. Even if the user is in motion, the portable electronic apparatus still capable of providing real-time and accurate information to the user by updating a ranking result and a map image according to a latest position of the user.

The advantages and spirit related to the present disclosure can be further understood via the following detailed description and drawings.

### BRIEF DESCRIPTION OF THE DRAWINGS

FIG. 1 is a block diagram of a portable electronic apparatus in accordance with an embodiment of the present disclosure.

FIG. 2A to FIG. 2F respectively show different images displayed by a portable electronic apparatus in different operation statuses in accordance with an embodiment of the present disclosure.

FIG. 3 is a flow chart of a method for operating a portable electronic apparatus in accordance with another embodiment of the present disclosure.

FIG. 4 and FIG. 5 are respectively flow charts of a method for operating a portable electronic apparatus in accordance with an embodiment of the present disclosure.

### DETAILED DESCRIPTION OF THE PREFERRED EMBODIMENT

According to an embodiment of the present disclosure, a portable electronic apparatus may be a common mobile communication apparatus, e.g., a mobile phone, a PDA, or other types of portable electronic apparatuses.

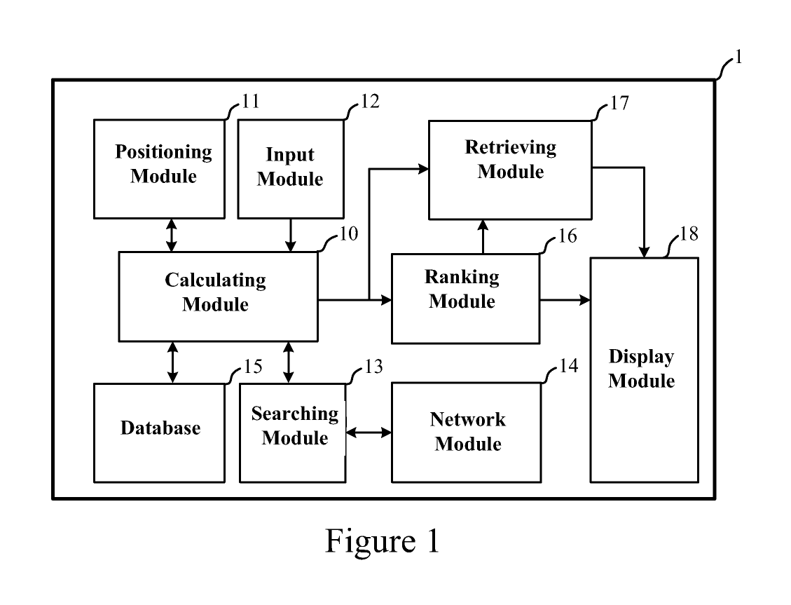

FIG. 1 shows a block diagram of a portable electronic apparatus in accordance with an embodiment of the present disclosure. A portable electronic apparatus 1 comprises a calculating module 10, a positioning module 11, an input module 12, a searching module 13, a network module 14, a database 15, a ranking module 16, a retrieving module 17, and a display module 18. The calculating 10 is respectively coupled to the positioning module 11, the input module 12, the searching module 13, the database 15, the ranking module 16 and the retrieving module 17. The network module 14 is coupled to the searching module 13. The ranking module 16 is respectively coupled to the retrieving module 17 and the display module 18. The retrieving module 17 is coupled to the display module 18. The modules of the portable electronic apparatus 1 are described in detail below.

In the portable electronic apparatus 1, the calculating module 10 respectively calculates a plurality of relative distances between a plurality of connect information and a target position, and compares the relative distances with a predetermined distance to generate at least one marked information. Generally speaking, the target position, the plurality of connect information and the at least one marked information are represented by, for example, name ,addresses, phone number ,longitude and latitude coordinates or other types of coordinates. The predetermined distance may be a range (e.g., 500 meters) from the target position that is regarded as a central point, or a range (e.g., 300 meters) towards a certain direction (e.g., a left upper side) from the target position regarded as a corner (e.g., a lower right corner). The predetermined distance may be defined as a predetermined value according to practical requirements, but it shall not be construed as limiting the present disclosure.

An approach of how the portable electronic apparatus 1 obtains connect information and a target position is described below. In practical applications, various types of approaches may be applied to obtain the target position by the portable electronic apparatus 1. For example, when receiving signals transmitted from a plurality of satellites of a Global Positioning System (GPS), the positioning module 11 calculates the target position according to the signals, and then transmits the target position to the calculating module 10. Generally speaking, apart from the GPS, the positioning module may also receive signals from other satellites of the Assisted Global Positioning System (AGPS), the Global Navigation Satellite System (GLONASS) or the Galileo Satellite Navigation Positioning System, and calculates the target position according to the received signals.

In addition, the user may also directly input via the input module 12 an address or longitude and latitude coordinates, which are then transmitted to the calculating module 10. In practice, the input module 12 may be a keyboard, a button group, a handwriting pad, a voice control input device or other apparatuses having an input function. For example, supposing that the input module 12 is a handwriting pad and the user wishes to arrive at the target position having an address “No. 122, M Street, A City”, the user may write the address “No. 122, M Street, A City” on the handwriting pad to complete inputting the target position. It is to be noted that, the portable electronic apparatus 1 is not limited to inputting information via hardware (e.g., buttons); the user may input the target position via an input interface on a screen or a touch control approach instead.

Various types of approaches may be applied to obtain the plurality of connect information by the portable electronic apparatus 1. For example, the calculating module 10 may directly obtain the plurality of connect information from a phone book (or an address list) stored in the database 15 of the portable electronic apparatus 1, or from a phone book (or an address list) stored in an external apparatus. In practice, since the phone book (or the address list) is stored with a plurality of contact information entries each comprising a name, a phone number, an address and the like, the calculating module 10 regards all addresses of the plurality of contact information entries in the phone book (or the address list) as the plurality of connect information. Alternatively, the calculating module 10 may only retrieve addresses from partial contact information that matches predetermined conditions (e.g., only contact information comprising address within A City or under a relatives category is retrieved) to serve as the plurality of candidate connect information.

In addition, the portable electronic apparatus 1 may obtain the plurality of connect information via a network searching approach. In this embodiment, being connected to the Internet via the network module 14, the searching module 13 of the portable electronic apparatus 1 searches for the plurality of connect information that match a predetermined condition of a search instruction according to the search instruction.

In practice, the predetermined condition of the search instruction may be associated with a range covered by a map image displayed by the portable electronic apparatus 1, types of locations corresponding to the plurality of connect information, and user purposes or requirements. Further, the predetermined condition may be a predetermined value or may be selected or defined according to practical requirements of the user.

For example, the searching module 13 searches the Internet via the network module 14, and searches for addresses of the plurality of connect information that match the predetermined condition and contact information, such as names and phone numbers corresponding to the plurality of connect information from webpage contexts near keywords that match the predetermined condition, so as to perform subsequent calculation of the calculation module 10.

In practical applications, for example, the predetermined conditions are that the radius of a displayed map image is 500 meters, the type of location is a restaurant, or the purpose of a user is to withdraw money. For example, supposing a user, who is carrying no cash while walking along a street, wishes to find a cash machine but cannot find an Automatic Teller Machine (ATM) or a bank in the vicinity. The user may then operate the mobile phone to define the predetermined condition as that the range covered by the map image has a 300-meter radius, and the purpose is to withdraw money, such that the mobile phone searches for banks or superstores having cash machine that match the predetermined conditions.

After the plurality of the connect information and the target position are obtained, the calculating module 10 respectively calculates relative distances between the plurality of connect information and the target position, and compares the relative distances with the predetermined distance to generate a plurality of marked information. The ranking module 16 ranks the plurality of marked information according to relative distances between each of the marked information and the target position to generate a ranking result. Generally speaking, a ranking approach applied by the ranking module 16 is to rank the connect information from near to far according to the relative distances between the connect information and the target positions, so as to satisfy user requirements and habits.

The retrieving module 17 retrieves a corresponding map image according to the target position and the predetermined distance. It is to be noted that, in this embodiment, the retrieving module 17 does not retrieve a map image according to the ranking result generated by the ranking module 16, meaning that operations of the retrieving module 17 and the ranking module 16 are independent from each other.

When the ranking module 16 and the retrieving module 17 respectively generate the ranking result and retrieve the map image, the display module 18 displays the map image and the at least one marked information simultaneously according to the ranking result. In practical applications, each of the marked information comprises, e.g., a name and a phone number.

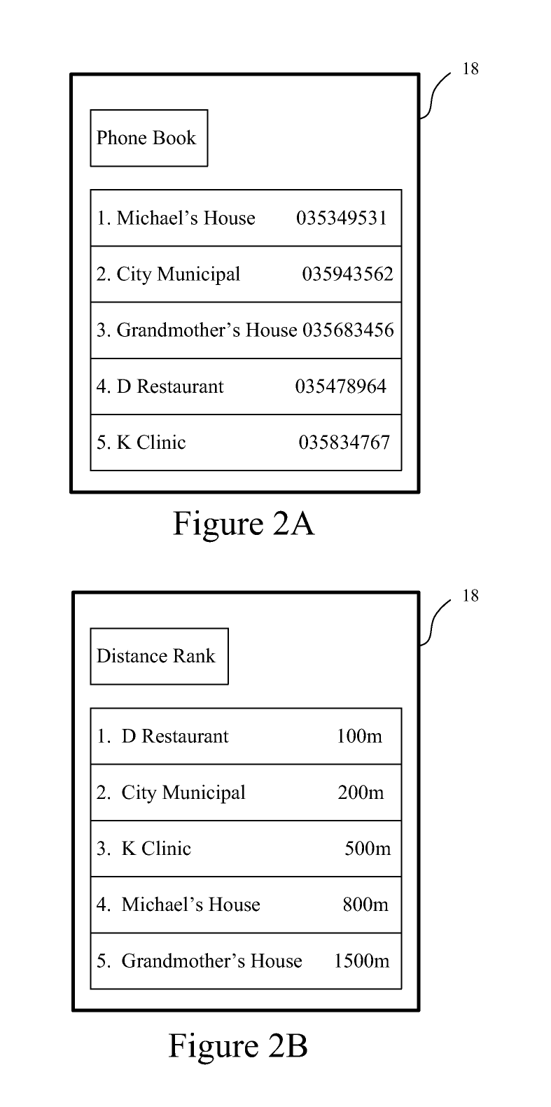

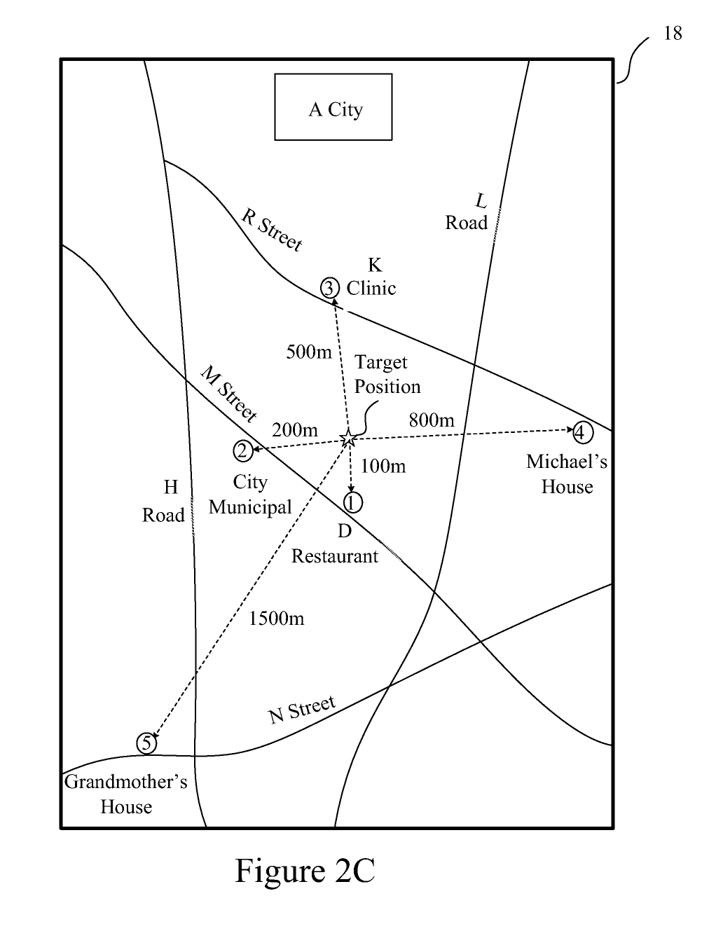

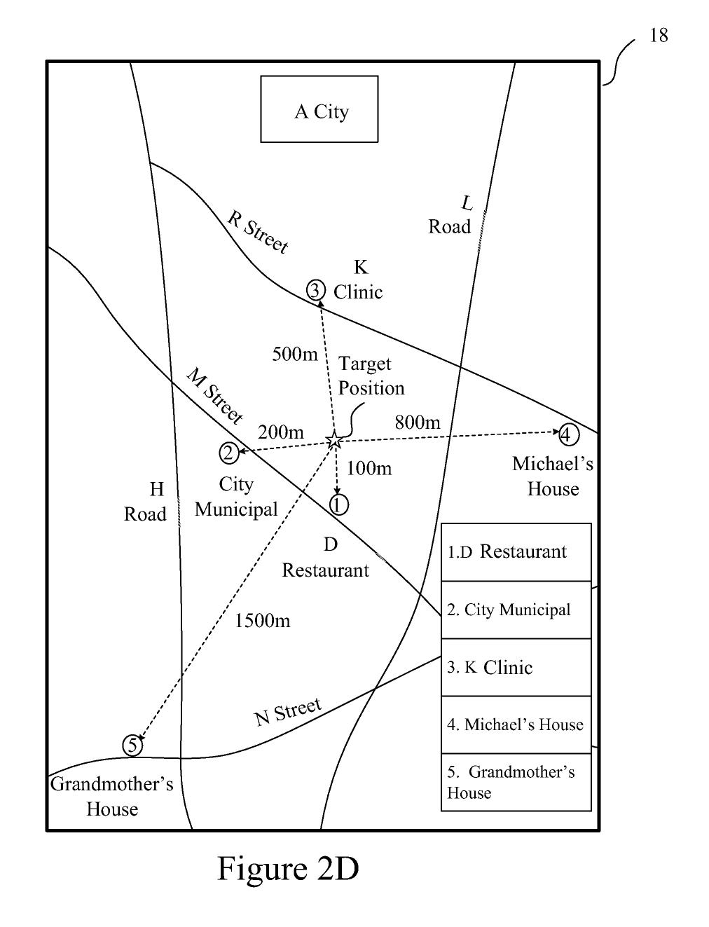

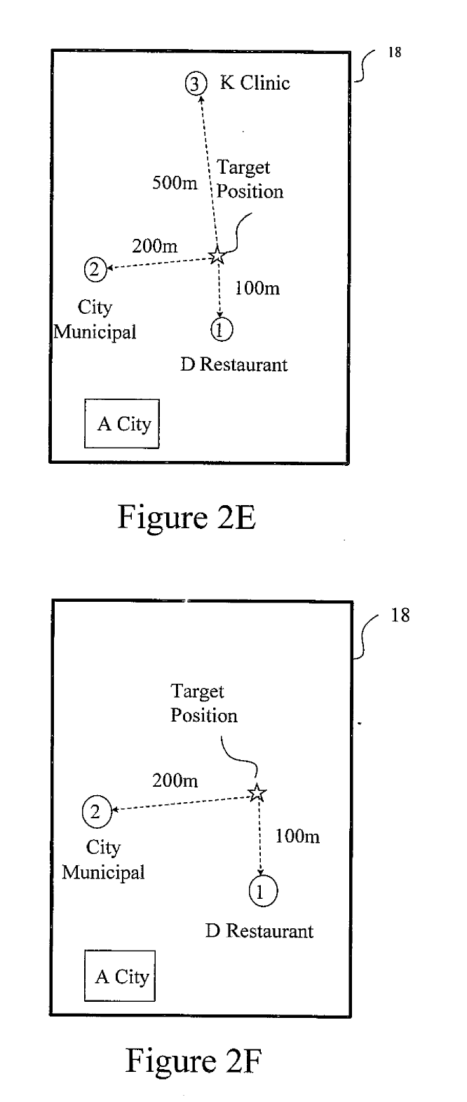

Practical applications are discussed below. For example, referring to FIG. 2A, supposing that five contact information entries originally displayed on the phone book of the portable electronic apparatus 1 are “no.1, Michael's House, 035349531”, “no.2, City Municipal, 035943562”, “no.3, Grandmother's House, 035683456”, “no.4, D Restaurant, 035478964”, and “no.5, K Clinic, 035834767”. After the calculation module 10 respectively calculates relative distances between coordinates corresponding to addresses of the contact information entries and a coordinate corresponding to the target position, the relative distance between “Michael's House” and the target position is 800 meters, the relative distance between “City Municipal” and the target position is 200 meters, the relative distance between “Grandmother's House” and the target position is 1500 meters, the relative distance between “D Restaurant” and the target position is 100 meters, and the relative distance between “K Clinic” and the target position is 500 meters.

The calculating module 10 respectively computes the five relative distances between the five connect information and the target position and compares the five relative distances with a predetermined distance to determine at least one marked information. Supposing that the predetermined distance is defined as being within a 2000-meter range from the target position, the five connect information that match the limitation of the predetermined distance are regarded as the marked information.

Therefore, the ranking module 16 of the portable electronic apparatus 1 ranks the five marked information from near to far according to the forgoing calculating result, and the ranking result is “no.1, D Restaurant, 100 meters”, “no.2, City Municipal, 200 meters”, “no.3, K Clinic, 500 meters”, “no.4, Michael's House, 800 meters”, and “no.5, Grandmother' House 1500 meters”. The ranking result is displayed on the display module 18 of the portable electronic apparatus 1 as shown in FIG. 2B.

In practical applications, in addition to only displaying the ranking result as a list on the display mode 18 of the portable electronic apparatus 1, the retrieving module 17 of the portable electronic apparatus 1 further retrieves a corresponding map image from a map database of the portable electronic apparatus 1 or on the Internet according to the target position and the predetermined distance, and displays the map image and the ranking result within a same image frame simultaneously, such that the user can obtain the relative distances between the marked information and the target position more instinctively and rapidly from the image frame displayed on the display module 18.

In practice, since the map image retrieved by the retrieving module 17 is determined according to the predetermined distance, a range covered by the map image supposedly matches the predetermined distance of the 2000-meter range from the target position, i.e., the map image displayed by the display module comprises the five marked information. In this embodiment, the target position, the marked information, and the relative distances between the marked information and the target position are marked on the map image to be browsed by the user.

Referring to FIG. 2C, except for the target position ⋆ and the marked information comprising D Restaurant \textcircled{1}, City Municipal \textcircled{2}, K Clinic 3, Michael's House \textcircled{4}, and Grandmother's House \textcircled{5}, relative distances between D Restaurant \textcircled{1}, City Municipal \textcircled{2}, K Clinic \textcircled{3}, Michael's House \textcircled{4} and Grandmother's House \textcircled{5} and the target position ⋆ are marked on the map image displayed on the display module 18, such that the user can easily find the positions of the marked information and the relative distances between the marked information and the target position on the map image. An image frame displayed on the display module 18 in FIG. 2D further comprises the listed ranking result at the lower right corner to provide a reference to the user.

However, it is possible that not all of the forgoing five connect information match the predetermined distance condition. For example, supposing that the predetermined distance is defined as being within a 600-meter range from the target position, only partial connect information that match the predetermined distance condition are regarded as the marked information. FIG. 2E shows a schematic diagram of limiting a range covered by a map image displayed on the display module according to the predetermined distance.

Referring to FIG. 2E, supposing that the user only wishes to browse locations within a 600-meter range from the target position, the user operates the portable electric apparatus to define the predetermined condition. When the relative distances between the coordinates corresponding to the addresses of the contact information and the coordinate corresponding to the target position are calculated, the calculating module 10 respectively calculates the relative distances between the five connect information and the target position within the 600-meter range from the target position. The ranking module 16 first excludes Michael's House and Grandmother's House having relative distances greater than 600 meters, and then selects D Restaurant, City Municipal and K Clinic from near to far as the marked information. The ranking module 16 then ranks the marked information of D Restaurant, City Municipal and K Clinic from near to far. Thus, the retrieving module 17 only retrieves a map image covering the 600-meter range from the target position according to the target position and the predetermined distance.

Therefore, in FIG. 2E, the target position ⋆, and the marked information comprising D Restaurant \textcircled{1}, City Municipal \textcircled{2} and K Clinic \textcircled{3} that match the predetermined distance condition are marked on the map image displayed on the display module 18, and Michael's House \textcircled{4} and Grandmother's House \textcircled{5} in FIG. 2C and FIG. 2D, which are out of the 600-meter range from the target position, do not match the predetermined distance condition and are hence not displayed in the map image displayed on the display module 18 in FIG. 2E. In practice, in addition to defining the range covered by the map image displayed on the display module 18 by the user, the range may also be a predetermined value or may be automatically adjusted to be suitable for the user.

It is to be noted that, in the foregoing embodiments, the range covered by the map image displayed on the display module 18 is adjusted by the portable electronic apparatus 1 according to the predetermined distance. However, in practical applications, the range covered by the map image displayed on the display module 18 may also be adjusted by the portable electronic apparatus 1 by other approaches.

For example, the portable electronic apparatus 1 can adjust the range covered by the map image by controlling the number of the marked information contained in the map image displayed by the display module 18. Referring to FIG. 2F, supposing that the user, instead of being informed on that many marked information from the map image displayed by the display module 18, only wishes to know two marked information that are nearest to the target position, the user can operate the portable electronic apparatus 1 to define a predetermined number to 2. When the calculating module 10 respectively calculates the relative distances between the coordinates corresponding to the addresses of the five contact information entries and the coordinate corresponding to the target position, the relative distances of the five connect information are obtained. The ranking module 16 ranks the five contact information entries from near to far according to the foregoing calculating result, and the ranking result is “no.1, D Restaurant, 100 meters”, “no.2, City Municipal, 200 meters”, “no.3, K Clinic, 500 meters”, “no.4, Michael's House, 800 meters”, and “no., Grandmother's House, 1500 meters”.

The ranking module 16 selects the first two connect information, which are “no.1, D Restaurant” and “no.2, City Municipal” from the ranking result, as the marked information. The retrieving module 17 retrieves a corresponding map image according to the target position and the two marked information “no.1, D Restaurant” and “no.2, City Municipal”. The display module 18 displays the map image and the two marked information only.

It is to be noted that, when the user handholding the portable electronic apparatus 1 begins moving, the foregoing target position changes and the relative distances between the connect information and the target position change as well, which may cause lost of accuracy of the original ranking result. In order to solve this problem, when detecting that the target position changes, the positioning module 11 transmits an update signal to (or triggers) the calculating module 10 to activate the calculating module 10 to re-calculate the relative distances between the connect information and the target position, and the ranking module 16 re-ranks the connect information to obtain an updated ranking result.

Other than the foregoing approaches, the portable electronic apparatus 1 also provides an update frequency according to practical requirements of the user. For example, the user can define the portable electronic apparatus 1 as that the map image displayed on display module 18 and the ranking result are updated every 5 seconds.

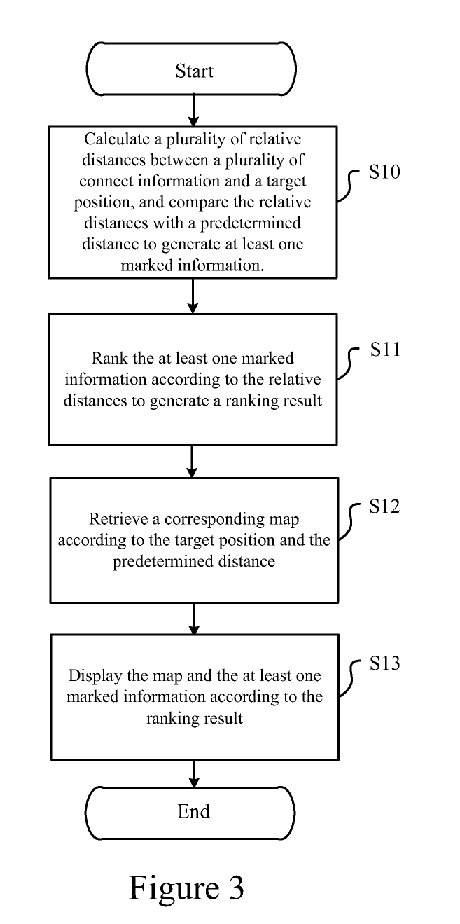

According to another embodiment, a method for operating a portable electronic apparatus is provided. FIG. 3 shows a flow chart of the method. In Step S10, the portable electronic apparatus calculates a plurality of relative distances between a plurality of connect information and a target position, and compares the relative distances with a predetermined distance to generate at least one marked information.

In practice, the portable electronic apparatus can receive signals transmitted from a plurality of satellites of a satellite positioning system to calculate the target position, or the target position is directly inputted into the portable electronic apparatus by a user. In addition, the portable electronic apparatus may directly obtain the plurality of connect information from a phone book stored in a database of the portable electronic apparatus, or obtain the plurality of connect information via the Internet.

In Step S11, the portable electronic apparatus ranks the at least one marked information according to the relative distances between the at least one marked information and the target position to generate a ranking result. In practical applications, the portable electronic apparatus ranks the at least one marked information from near to far according to relative distances between the at least one marked information and the target position.

In Step S12, the portable electronic apparatus retrieves a corresponding map image according to the target position and the predetermined distance. It is to be noted that, in this embodiment, Step S11 and S12 need not be performed in a specific order, i.e., Step 11 and Step 12 may be simultaneously performed, Step S11 is first performed and followed by Step 1, or Step S12 is first performed and followed by Step 11.

In Step S13, the portable electronic apparatus displays the map image and the at least one marked information according to the ranking result. In practice, the map image and the ranking result are integrated to a same image frame, including the target position, the at least one marked information and the relative distances, displayed on a screen of the portable electronic apparatus.

In practical applications, in addition to adjusting a range covered by the map image according to the predetermined distance, the portable electronic apparatus can adjust the range covered by the map image by controlling the number of the marked information contained in the map image.

In such a situation, a method for operating the portable electronic apparatus is slightly different from the foregoing steps. When relative distances between a plurality of connect information and a target position are calculated to obtain the relative distances corresponding to the plurality of connect information, the portable electronic apparatus ranks the plurality of connect information according to the relative distances to generate a ranking result, and selects a predetermined numbers of the plurality of marked information. After that, the portable electronic apparatus retrieves a corresponding map image according to the target position and the plurality of marked information. The portable electronic apparatus displays the map image and the plurality of marked information according to the ranking result.

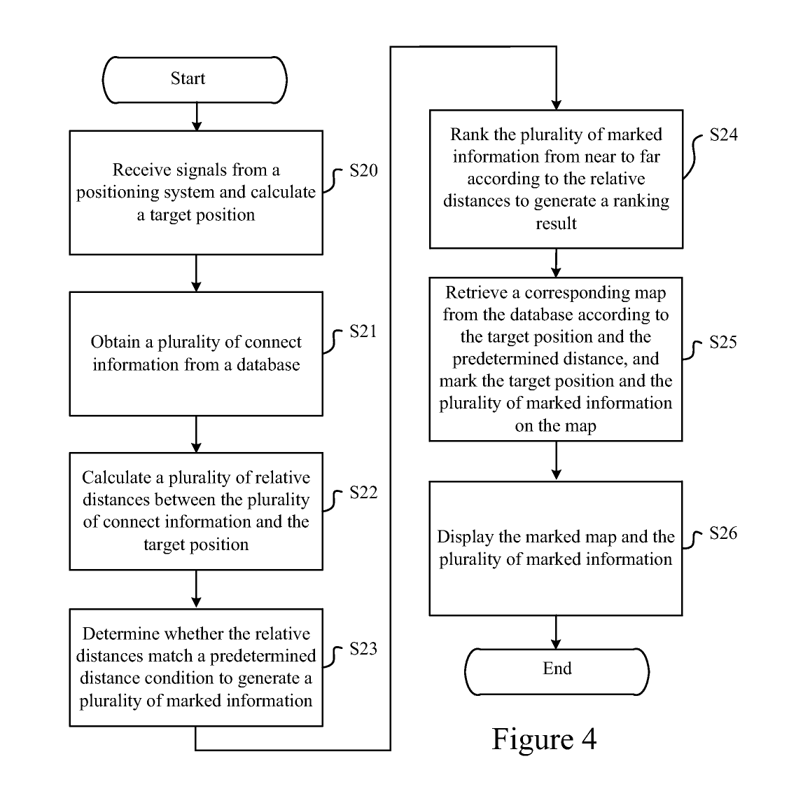

A practical example is to be described to illustrate detailed steps of the method for operating a portable electronic apparatus. Referring to FIG. 4, in Step S20, the portable electronic apparatus receives signals from a positioning system and calculates a target position of the portable electronic apparatus according to the received signals. In Step S21, the portable electronic apparatus obtains a plurality of connect information from a database. In Step S22 and S23, the portable electronic apparatus respectively calculates a plurality of relative distances between the plurality of connect information and the target position, and determines whether the relative distances between the plurality of connect information and the target position match a predetermined distance condition to generate a plurality of marked information.

In Step S24, the portable electronic apparatus ranks the plurality of marked information from near to far according to the relative distances to generate a ranking result. In Step S25, the portable electronic apparatus retrieves a corresponding map image from the database according to the target position and the predetermined distance, and marks the target position and the plurality of marked information on the map image. In Step S26, the portable electronic apparatus displays the marked map image and the plurality of marked information.

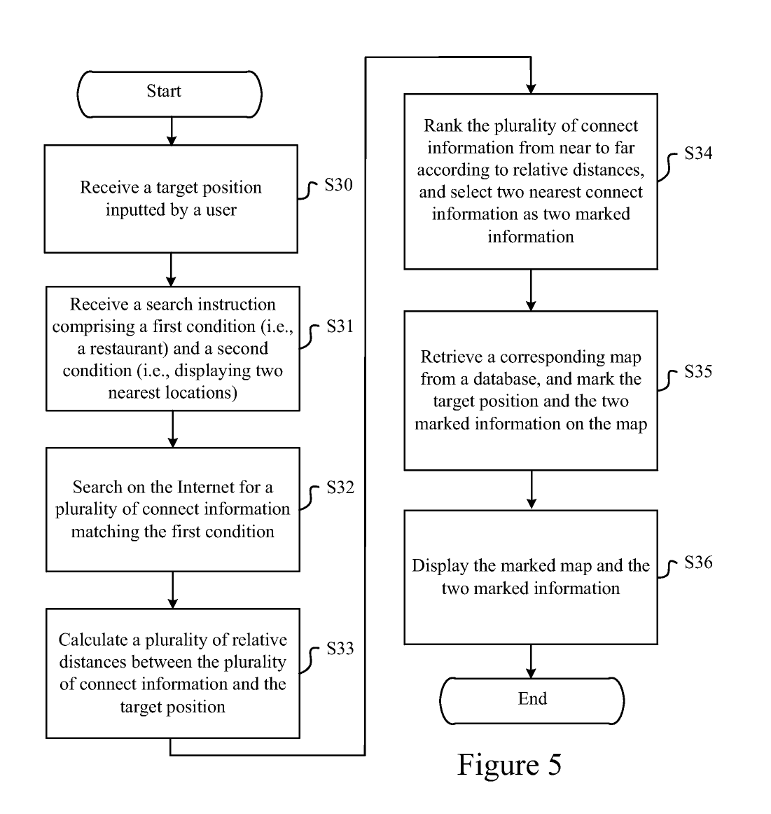

FIG. 5 shows a flow chart of another example of a method for operating a portable electronic apparatus. Referring to FIG. 5, in Step S30, the portable electronic apparatus receives a target position inputted by a user. In Step S31, the portable electronic apparatus receives a search instruction comprising a first condition (i.e., a restaurant) and a second condition (i.e., displaying two nearest locations). In Step S32, the portable electronic apparatus searches on the Internet for a plurality of connect information matching the first condition according to the search instruction. In Step S33, the portable electronic apparatus respectively calculates a plurality of relative distances between the plurality of connect information and the target position.

In Step S34, the portable electronic apparatus ranks the plurality of connect information from near to far according to relative distances between the plurality of connect information and the target position, and selects two nearest connect information as two marked information. In Step S35, the portable electronic apparatus retrieves a corresponding map image from a database, and marks the target position and the two marked information on the map image. In Step S36, the portable electronic apparatus displays the marked map image and the two marked information.

In conclusion, regardless of whether a target position is inputted by a user or is calculated via received signals from a satellite positioning system, a portable electronic apparatus according to the present disclosure ranks contact information entries stored in a phone book from near to far according to relative distances between positions corresponding to the contact information entries and the target position to generate a ranking result, and displays an image frame comprising the ranking result and the corresponding map image on a screen. In addition, the user is allowed to search with additional options, e.g., predetermined requirements and purposes (e.g., a restaurant or a bank is searched for). The portable electronic apparatus ranks names or phone numbers of restaurants or banks from near to far according to the relative distances, and displays the ranking result and the corresponding map image on the screen.

Accordingly, according to the present disclosure, a portable electronic apparatus is capable of assisting a user to easily obtain contact information and associated life information of various locations near a target position. Even if the user is in motion, the portable electronic apparatus according to the present disclosure can still update a ranking result and a map image according to a latest position of the user to provide real-time and accurate information to the user.

While the present disclosure has been described in terms of what is presently considered to be the most practical and preferred embodiments, it is to be understood that the present disclosure needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A portable electronic apparatus, comprising:
a database that stores contact information of a plurality of contacts;
a calculating module, coupled to the database, that calculates a plurality of relative distances between the plurality of contacts and a target position, and generates a plurality of instances of marked information by comparing the relative distances with a predetermined distance;
a retrieving module that retrieves a map image according to the target position and the predetermined distance;
a ranking module, coupled to the calculating module, that ranks the marked information according to the relative distances to generate a ranking result; and
a display module, coupled to the ranking module and the retrieving module, that simultaneously displays the map image and the marked information according to the ranking result.

2. The apparatus as claimed in claim 1, further comprising:
a positioning module, coupled to the calculating module, that receives signals of a positioning system and calculates the target position according to the received signals.

3. The apparatus as claimed in claim 2, wherein the position module transmits an update signal to activate the calculating module to re-calculate the plurality of relative distances when the target position is changed.

4. The apparatus as claimed in claim 1, further comprising:
an input module, coupled to the calculating module, that receives input of the target position.

5. The apparatus as claimed in claim 1, wherein the ranking module generates the ranking result by ranking from near to far according to the relative distances.

6. The apparatus as claimed in claim 1, wherein each of the instances of marked information comprises a name and a phone number.

7. The apparatus as claimed in claim 1, wherein the contact information of a contact comprises a name, a phone number, and an address.

8. The apparatus as claimed in claim 1, further comprising:
a network module, coupled to the Internet; and
a searching module, coupled to the network module and the calculating module, that searches for the contact information of the plurality of contacts via the network module from the Internet according to a predetermined search condition, the predetermined search condition being associated with the predetermined distance and a classification of the contact information.

9. The apparatus as claimed in claim 1, wherein the display module simultaneously displays the map image and the marked information in an image frame.

10. The apparatus as claimed in claim 1, wherein the retrieving module retrieves the map image from a map database on the Internet or a map database of the portable electronic apparatus.

11. A portable electronic apparatus, comprising:
a database that stores contact information of a plurality of contacts;
a calculating module, coupled to the database, that calculates a plurality of relative distances between the plurality of contacts and a target position;
a ranking module, coupled to the calculating module, that ranks the contact information according to the relative distances, and selects a plurality of instances of marked information from the ranked contact information;
a retrieving module, coupled to the ranking module, that retrieves a corresponding map image according to the target position and the marked information; and
a display module, coupled to the ranking module and the retrieving module, that simultaneously displays the map image and the plurality of marked information.

12. The apparatus as claimed in claim 11, wherein the ranking module ranks the contact information from near to far according to the relative distances.

13. The apparatus as claimed in claim 11, wherein each instance of the marked information comprises a name and a phone number.

14. The apparatus as claimed in claim 11, further comprising:
a network module coupled to the Internet; and
a searching module, coupled to the network module and the calculating module, that searches for the contact information via the network module from the Internet according to a predetermined search condition, the predetermined search condition being associated with the predetermined distance and a classification of the contact information.

15. The apparatus as claimed in claim 11, wherein the display module displays the map image and the marked information in an image frame simultaneously.

16. A method for operating a portable electronic apparatus having a database storing contact information of a plurality of contacts, the method comprising:
calculating a plurality of relative distances between the plurality of contacts and a target position;
generating a plurality of instances of marked information by comparing the relative distances with a predetermined distance;
ranking the marked information according to the relative distances;
retrieving a map image according to the target position and the predetermined distance; and
displaying the map image and the marked information simultaneously.

17. The method as claimed in claim 16, wherein the target position is calculated according to signals that is received from a positioning system or inputted by a user.

18. The method as claimed in claim 16, wherein the plurality of relative distances is re-calculated when the target position is changed.

19. The method as claimed in claim 16, wherein the contact information is searched from the Internet according to a predetermined search condition associated with the predetermined distance and a classification of the contact information.

20. The method as claimed in claim 16, wherein the map image is retrieved from a map database on the Internet or a map database of the portable electronic apparatus.
